(19) United States
(12) Patent Application Publication
(10) Pub. No.: US 2024/0020153 A1
(43) Pub. Date: Jan. 18, 2024

(54) INACTIVE COMPUTING PROCESS IDENTIFICATION

(71) Applicant: HEWLETT-PACKARD DEVELOPMENT COMPANY, L.P., Spring, TX (US)

(72) Inventors: Jie Xu, Shanghai (CN); Xiao-Lu Zhang, Shanghai (CN)

(73) Assignee: HEWLETT-PACKARD DEVELOPMENT COMPANY, L.P., Spring, TX (US)

(21) Appl. No.: 17/866,874

(22) Filed: Jul. 18, 2022

(51) Int. Cl. G06F 9/48; G06F 11/07; G06F 11/30

(52) U.S. Cl. CPC G06F 9/4881; G06F 11/0793; G06F 11/3051

(57) ABSTRACT

In an example in accordance with the present disclosure, a system is described. The system includes a process monitor. The process monitor identifies a computing process to monitor and monitors a process characteristic of a monitored computing process. The system also includes a controller. The controller compares the process characteristic to threshold criteria for the process characteristic to identify an inactive computing process. Responsive to the identification of an inactive computing process, the controller also takes a remedial action to address the inactivity.

### BACKGROUND

Computing devices are used to execute a wide variety of operations. Some users interact with multiple computing devices daily. Computing devices execute computer program instructions to perform an intended operation. A process refers to a collection of program instructions that work to execute the intended operation. That is, a process refers to a set of instructions that a processor of a computing device executes. As an example, a printing process may include program code that runs in the background and monitors print settings such as an ink level. A process is made up of sequences of code referred to as threads which are the smallest set of code that is individually addressable by a processor.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a diagram of a system for identifying inactive computing processes, according to an example of the principles described herein.

FIG. 2 is a diagram of a thin client incorporating the system for identifying inactive computing processes, according to an example of the principles described herein.

FIG. 3 is a flowchart of a method for identifying inactive computing processes, according to an example of the principles described herein.

FIG. 4 is a flowchart of a method for identifying inactive computing processes, according to an example of the principles described herein.

FIG. 5 depicts a non-transitory machine-readable storage medium for identifying inactive computing processes, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations that coincide with the description; however, the description is not limited to the examples and/or implementations provided in the drawings.

### DETAILED DESCRIPTION

Computing devices are used to perform any number of digital operations. Specifically, a processor retrieves machine-readable executable code from a memory device and executes the machine-readable executable code. A set of instructions executed by a processor to perform a particular function may be referred to as a process. For example, a process may open a word processing application. As such, process execution is at the heart of computing device functionality.

However, from time to time a process may become inactive for any variety of reasons. For example, a process may stall due to an error in the program code, an incompatibility with other program code or underlying data, or any number of other reasons. In another example, a process may be idle. Specifically, the process may not be actively performing any operation.

As yet another specific example, a process may be awaiting user input and for which a user is unaware that user input is required. For example, certain computing devices referred to as thin clients may execute operations that are not visible to a user of the thin client, but are visible to a thin client administrator who may be a remote administrator. In any of these circumstances, an inactive (e.g., stalled, idle, or awaiting user input) process may not allow the computing device to execute the intended operation. That is, if the process is not completed, the intended function is not carried out and the execution of other processes may be impacted and prevented from executing. For example, when a process to install an application is stalled or idle, the application to be installed does not appear on the computing device and a user is unable to utilize the application. In some particular cases where processes are organized hierarchically, an inactive child process may impede the parent process from executing. This may result in a freeze, or other inability of a computing device to operate as instructed by a user.

While an inactive process may be terminated, a process that should be terminated may not be noticed by a user, administrator, or the computing device itself until after a long period of time if at all. This may be particularly demonstrated in the example of a thin client where a user of the thin client may be unaware of all the processes executing on the thin client. For example, some processes are executed in a session that does not generate a user interface or that may be a background process. If one of these background processes becomes inactive, it could affect the functionality of certain hardware devices or applications on the computing device. Because it is a background process, a user may not even know that such has become inactive. Thus, the cause of the malfunction may be undiscoverable by a local user.

Moreover, even though a process is inactive, it may still be acted upon by a processor, thus consuming processing resources. Some monitoring systems may not identify an inactive process for 30 minutes or longer. As such, if identified at all, an inactive process may not be identified for a long period of time.

Accordingly, the present specification describes a system, method, and machine-readable storage medium with instructions thereon to monitor the activity of a process, and any child processes. When the system identifies a process and/or child processes that are inactive for a period of time, for example one minute, the system terminate the process and takes a remedial action such as re-executing the process or notifying an administrator.

As a particular example, an installer process may include a wrapper file, which calls a child process which calls a separate executable file. After the wrapper launches the executable file, the wrapper may close. As described above, such a process may be a background process that does not execute in an environment where a user observes the execution of the executable installer file. In the event that this executable installer file does not properly execute, a user and/or administrator may be unaware of such improper or incomplete execution.

The present specification monitors process characteristics to determine if the process is idle for a predetermined period of time, such as 1 minute. If the process is identified as inactive for this period of time, the process is terminated. The system can then send a notification to an administrator to check on the code of the process to identify any errors that may exist, re-run the process, or perform any variety of remedial action. In other words, the present specification describes a system to determine whether a process within a process tree has stalled (or is waiting for user input) which may block task execution. Inactive processes may be terminated and/or a notification may be provided to an administrator or other user such that the administrator may take corrective actions to address the identified issue.

Examples of characteristics that may be monitored and that indicate an idle/stalled process include, but are not limited to 1) low or zero central processing unit (CPU) usage, 2) thread number changes, 3) changes to a state of a memory device; 4) handle number changes; 5) disk activity; 6) network connection changes; 7) network activity changes; 8) user interface changes; and 9) prompts for user input. While particular reference is made to particular characteristics to track, any number of characteristics may be tracked to identify inactive (e.g., stalled, idle, or timed-out) processes.

The present system, method, and machine-readable program code can identify stalled child processes as well. In other systems, a child process may not be monitored or terminated. Accordingly, the system may wait for exit of the process and the child processes. When the system finds the process and its child processes are idle for a while, the system may terminate the process and its child processes automatically and report failure.

As a specific example, the system may wait for a launched process to exit. If the launched process spawns a child process, and the child process is not completed when the launched process is completed, the child process is said to be out of control. As a specific example, an administrator may send a task that would execute process A. Process A may spawn process B, which spawns process C. For example, a file install.cmd may be executed to silently install a network sniffer tool. As part of the installation of the network sniffer tool, other processes may be spawned which install other objects. In this example, the present system and method may be able to determine that process C has stalled and provide information of such to an administrator such that the administrator may take corrective action to fix process C.

As another example, a first task may execute process A and a second task may execute a process B where the second task has a dependency upon Process A. That is, the second task may not execute until process A completes. As such, a stall of process A prevents the second task from being completed. Accordingly, the method, system, and program code of the present specification allows an administrator to identify that the reason of the failure of execution of the first task is due to a stall and can make a corrective action so that the second task can successfully run after the problem is fixed.

Specifically, the present specification describes a system. The system includes a process monitor to 1) identify a computing process to monitor and 2) monitor a process characteristic of a monitored computing process. The system also includes a controller. The controller compares process characteristic to threshold criteria for the process characteristic to identify an inactive computing process. Responsive to the identification of an inactive computing process, the controller takes a remedial action to address the inactivity.

The present specification also describes a method. Specifically, for a process hierarchy executing on a computing device, a process monitor monitors a process characteristic of a monitored computing process. At the expiration of a time interval, a controller 1) compares a process characteristic to threshold criteria for the process characteristic to identify an inactive computing process and 2) takes a remedial action to address an inactivity responsive to the identification of an inactive computing process.

The present specification also describes a non-transitory machine-readable storage medium encoded with instructions executable by a processor. The machine-readable storage medium includes instructions to, for each process executing on a computing device 1) monitor a process characteristic of a monitored computing process, 2) compare a process characteristic to threshold criteria at the expiration of a time interval, for the process characteristic to identify an inactive computing process, and 3) terminate an inactive computing process responsive to identification of an inactive computing process.

As described above, such a system, method, and machine-readable storage medium may, for example, 1) provide enhanced monitoring of parent and child processes in a process hierarchy; 2) provide quicker resolution of inactive processes; 3) reduce strain and free processing resources from queued up and stalled processes; and 4) allow execution of downstream processes of a stalled process. However, it is contemplated that the device, method, and machine-readable storage medium disclosed herein may address other matters and deficiencies in a number of technical areas, for example.

As used in the present specification and in the appended claims, the term “a number of” or similar language is meant to be understood broadly as any positive number including 1 to infinity.

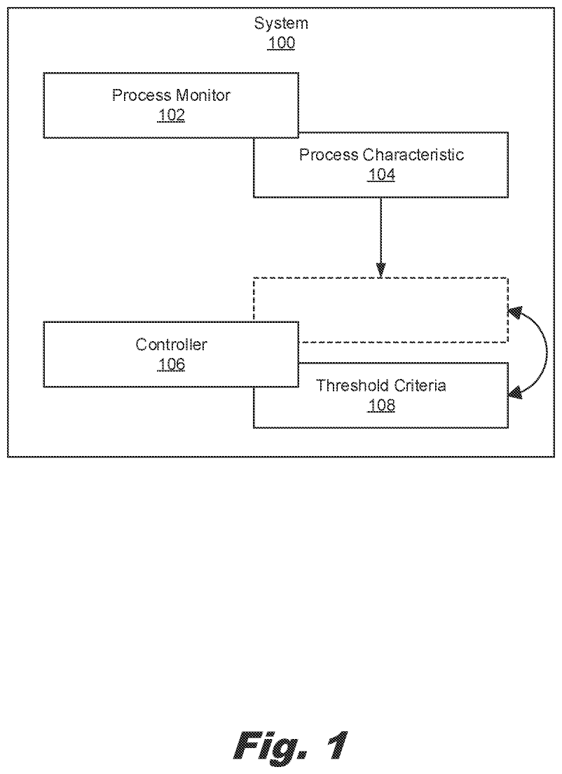

Turning now to the figures, FIG. 1 is a diagram of a system (100) for identifying inactive computing processes, according to an example of the principles described herein. As described above, processes refer to sets of instructions which are executed by a processor to carry out an intended function. When a process stalls, times-out, or is otherwise inactive, the intended function is not carried out, and in some example other dependent processes are blocked from executing their intended function. As such, stalled processes prevent the computing device from performing as intended.

Furthermore, it may be the case that inactive processes are undetected and/or undetectable. For example, processes may be background processes, or executed in a session of a thin client where no user interface is presented to indicate a status of the process. In these examples, a stalled process may be addressed when recognized by a processor as stalled, which may occur after a significant period of time, say 30 minutes. By comparison, the present specification describes a system (100) to quickly and efficiently identify processes that are inactive (i.e., stalled, are idle, have timed-out, or are awaiting user input) and to take some form of remedial action. The present system (100) may be implemented on any number of computing device including thin clients, desktop computers, laptop computers, mobile devices, servers, computing devices that rely on remote operating systems, and gaming systems among others. While particular reference is made to particular computing devices, the system (100) may be implemented as any number of computing devices with a processor and a memory device.

The system (100) includes a process monitor (102) to identify a computing process to monitor. As used in the present specification and in the appended claims, the term “process monitor” may refer to an electronic component which may include a processor and memory. The processor may include the hardware architecture to retrieve executable code from the memory and execute the executable code. As specific examples, the process monitor (102) as described herein may include computer readable storage medium, and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller cause the process monitor (102) to implement at least the functionality of selecting processes to monitor and monitor characteristics (104) of selected processes as described below.

As described above, a computing device may execute processes to perform requested tasks. In some examples, the process monitor (102) monitors a subset of processes. For example, via a user interface, an administrator or other user may select certain processes to be monitored. Processes for monitoring may be selected based on any criteria such as priority, susceptibility to becoming inactive, history of inactivity, or any other criteria. In another example, the process monitor (102) may monitor all processes of the computing device. That is, rather than analyzing a subset of executing processes, the process monitor (102) may monitor each process that is actively executing on the computing device.

The processes that are monitored may be of a variety of types. Specifically, a process may be a parent or a child process. That is, the processes that are executed may be represented as a hierarchy where certain processes are child processes that are called by a parent process. An example of a parent process is a wrapper which encapsulates one or more other processes. As an example, a website process to “send mail,” may call various other processes such as a process to form data, a process to check the email for spam, and a process to send the message using a mail server. As another example, a parent process may call a child process which executes an executable notepad application. As such, the process monitor (102) not only monitors the parent process, but also monitors the child process that is reliant or at a different hierarchical level, than the parent process.

As another example, the computing process that is selected for monitoring may be a subsequent process that is initialized upon completion of another computing process. For example, a first task may include a first process. Upon completion of the first task a second task with a second process is executed. All this is to say that the process monitor (102) may monitor the characteristics (104) of any type of executing process.

In any case, the process monitor (102) monitors a process characteristic (104) of a monitored computing process. As it executes, the process has certain characteristics (104). For example, the process may utilize hardware resources. As such, a process characteristic (104) may identify how, what, and to what extent the process relies on hardware resources of the computing device. As an example, a process is made up of threads. Accordingly, the thread count of a process may be a process characteristic (104). Accordingly, the process monitor (102) can monitor the thread count, and other process characteristics (104), and in so doing can identify whether a process is inactive.

As a particular example, the process monitor (102) may monitor the process CPU usage which indicates the CPU utilization of the process. Throughout execution of the process, the CPU usage of the process may change over time. Accordingly, a CPU usage that does not change over time, or that is low or zero for an extended period of time may indicate that a process has stalled.

As another example, the process monitor (102) may monitor the process memory usage which indicates the physical memory in use by the process. Throughout execution of the process, the process memory usage may change. Accordingly, a memory usage that does not change over time, or that is low or zero for an extended period of time may indicate that a process has stalled.

As another example, the process monitor (102) may monitor the process disk usage which indicates the physical disks in use by the process. As with the other examples, throughout execution of the process, the process disk usage may change. Accordingly, a disk usage that does not change over time, or that is low or zero for an extended period of time may indicate that a process has stalled.

As another example, the process monitor (102) may monitor the network input/output state or transfer rate. That is, some processes may transfer information to and from other computing devices that are connected via a network. Over the course of time, whether or not information is being transferred, and the rate at which data is transferred may vary. Accordingly, a network input/output rate that does not change over time, or that is zero for an extended period of time may indicate that a process has stalled.

As another example, the process monitor (102) may monitor a process thread number. As described above, in executing its intended function, a process may execute a number of threads, which are smaller sections of code that are combined into a process. As with the other process characteristics (104), the thread number may change throughout execution of the process. Accordingly, a process thread number that does not change over time, or that is low or zero for an extended period of time may indicate that a process has stalled.

As another example, the process monitor (102) may monitor a process handle number. A process handle is a reference to a resource that is used when a process references blocks of memory or some other object that is managed by a different system. As with the other process characteristics (104), the handle number may change throughout execution of the process. Accordingly, a process handle number that does not change over time, or that is low or zero for an extended period of time may indicate that a process has stalled.

As yet another example, the process monitor (102) may monitor a user interface (UI) window. That is, some processes may rely on user input. For example, an installer may request user verification to install an application. In some cases, a user may be away from their computer such that they do not provide the requested verification. In another example, the process may be running in a window that does not present a user interface. For example, a thin client may execute a service window that is a background operation and that is not accessible to a user. A process may run in this service window and may request user authentication to install an application. However, as the installer is executed in a service window that is not accessible to the user of the thin client, the user may not be aware of or be able to provide the requested verification. This is an example of an idle process that is awaiting user input, which user input may not be able to be received. Accordingly, the process monitor (102) may monitor the presence of a user interface, whether accessible to a user or not, to determine whether a process is inactive.

Other examples of process characteristics (104) that may be monitored include a computing device sleep state and a responsive state of an application associated with the process. Note that while particular reference is made to particular process characteristics (104), the process monitor (102) may be set up to monitor these or different process characteristics (104). Moreover, it should be noted that the process monitor (102) may monitor multiple process characteristics (104).

The system may also include a controller (106) to identify and remedy inactive processes. As used in the present specification and in the appended claims, the term “controller” may refer to an electronic component which may include a processor and memory. The processor may include the hardware architecture to retrieve executable code from the memory and execute the executable code. As specific examples, the controller (106) as described herein may include computer readable storage medium, and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (106) cause the controller to implement at least the functionality of identifying and remedying an inactive process as described below.

Specifically, the controller (106) receives a process characteristic (104) from the process monitor (102) and compares the process characteristic (104), or process characteristics (104), to threshold criteria (108) for the process characteristic (104) to identify an inactive computing process.

As described above, a process may be inactive for a variety of reasons. As a first example, an inactive computing process may be one that is stalled or otherwise timed out. A process may stall for a variety of reasons including inexecutable code, incompatibility with another executing operation or hardware component, or some error relating to the application with which the process is executing.

As another example, an inactive computing process may be a computing process that is idle. That is, for a variety of reasons, the computing process may not be executing any function.

As yet another example, the inactive computing process may be a computing process that is awaiting user input, but is not receiving user input. That is, as described above, some processes present a user interface or a prompt to a user to provide some information and/or authorization to proceed. Execution of that process is therefore blocked until such information and/or authorization is received. As such, when a user does not notice of the prompt or user interface, when the process is a background process, or otherwise is executed in a window, such as a service window, that is inaccessible to a user, the trigger to continue execution of the process may be unrealized.

In any of these instances, an inactive process hinders the performance of the intended functionality and may impede the performance and/or execution of other processes. Accordingly, the controller (106) operates to identify processes as inactive and take some remedial action. Specifically, this is done by comparing the process characteristic(s) (104) to threshold criteria (108). In some examples, the threshold criteria (108) may indicate a rate of change of the processor characteristic (104) over a period of time. For example, the threshold criteria (108) may indicate that if the process characteristic (104) does not change in value over a predetermined period of time, the associated process is inactive. In a specific example, the measured metric is a number of threads of the process currently executing and the predetermined period of time is 1 minute. Accordingly, the controller (106) may measure the thread count of the process and if the thread count does changes over time, the controller (106) may identify this as an active process. By comparison, if the process thread count does not change value over a one-minute interval, the controller (106) may identify this process as an inactive process. As such, the threshold criteria (108) may be a rate of change over a period of time.

In another example, the threshold criteria (108) may be an upper or lower limit. For example, the process characteristic (104) to be monitored may be CPU usage. Accordingly, the controller (106) may compare the process CPU usage characteristic (104) to determine if it is below a threshold amount over a period of time of 1 minute. If CPU usage is not below the threshold amount over a one-minute interval, the controller (106) may identify this as an active process. By comparison, if the process CPU usage is below the threshold amount over a one-minute interval, the controller (106) may identify this process as an inactive process.

It should be noted that while particular reference has been made to comparison of a single process characteristic (104) to a single threshold criterion (108), the controller (106) may compare multiple process characteristics (104) to respective threshold criteria (108) to identify the inactive computing process. That is, while CPU usage may be indicative of an inactive process, by itself such a characteristic may not be dispositive of an inactive computing process. Accordingly, an output of a comparison of multiple of the aforementioned or other process characteristics (104) to respective threshold criteria (108) may provide a more complete indication of process status.

Responsive to the identification of an inactive computing process, the controller (106) may take a remedial action to address the inactivity, which remedial action may take a variety of forms. For example, the controller (106) may terminate the process. Doing so frees up the resources used to execute the process such that other processes may utilize those resources to execute. Terminating the process also allows for the process to be re-run. In other words, terminating the process unblocks the performance of an intended function.

The remedial action may also include re-running the process. That is, it may be the case that simply re-executing the process may remedy the circumstances that initially led to the inactivity of the process. As yet another example, the remedial action may be to provide a notification to a user, which user may be a local user of a thin client or an administrator of the thin client. The notification to the administrator may allow the administrator to troubleshoot the process and computing device to identify the root cause of the inactivity. In some examples, along with the notification of the inactivity, the controller (106) may send metadata to provide additional information to the administrator. For example, the metadata may provide a status of threads executed and timestamps for execution such that an administrator may determine where along the execution timeline the stall occurred. Doing so provides a targeted approach to error identification.

In some examples, the remedial action that is taken may be based on the process that is identified as inactive. For example, for a first process the remedial action may be to re-execute the process while the remedial action for a second process may be to notify an administrator.

In some examples the remedial action that is taken is based on historical data and may differ between cyclic identification of inactivity. For example, upon a first occurrence, or first threshold number of occurrences, of inactivity, the process may be terminated and re-executed. If a process has a history of inactivity, the remedial action may be to terminate the process and provide a notification to a user of the inactivity as well as a historical record regarding inactivity and applied remedial actions to the administrator to address. While particular reference has been made to particular remedial actions, other remedial actions may be taken responsive to identification of an inactive process.

As such, the present specification describes a system (100) that quickly identifies inactive processes in a shorter amount of time (i.e., one minute vs. 30 minutes), and remediates the situation such that the process and/or other processes may be executed as intended.

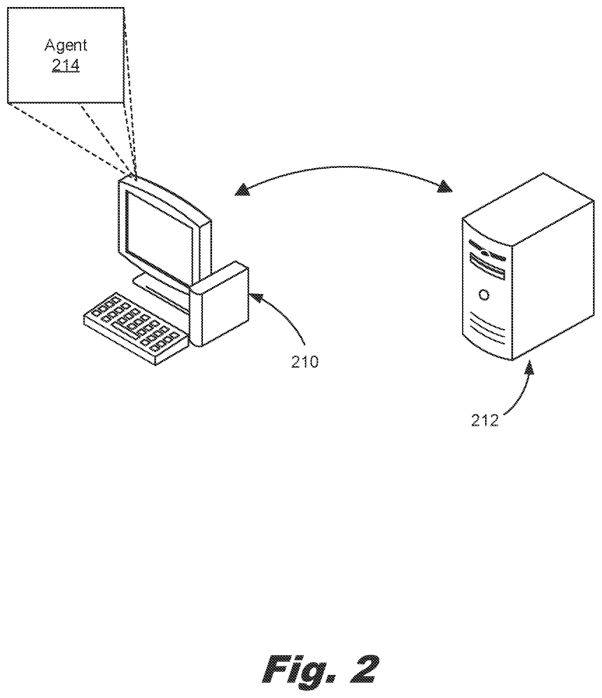

FIG. 2 is a diagram of a thin client (210) incorporating the system (100) for identifying inactive computing processes, according to an example of the principles described herein. In general, a thin client (210) is a computing device that runs from resources that are housed, or operated from, a server (212) instead of on a localized hard drive. As such, the system (100) may be an agent (214) installed on a client computing device, which may be a thin client (210), where a server (212) provides an operating system and other hardware resources such as memory devices to the client computing device. In this example, an administrator can login to the server (212), for example via a web browser and the agent (214) executes tasks or actions from the administrator/server (212). Put another way, the agent (214) may be running in service mode.

As described above, some processes which are executed by the agent (214) are not visible or are inaccessible to a user of the thin client (210). For example, the agent (214) may be able to run an installer, but may not display a user interface to the local user. As such, the local user may not be aware of any prompt for user input and may not know whether an executing process has stalled.

As a specific example, the thin client (210) may execute a service window that runs certain processes in a background such that local users do not have access to alter those processes. Allowing local users access to these background processes may pose a security threat and may subject the processes to unwanted alteration. For example, within an organization, an administrator may wish to limit the employee's ability to alter certain features of the network. As such, the administrator may manage updates, installs, etc. of the thin clients (210) via a service window that is running on the thin client (210) but that is inaccessible to the local user. Such a service window may be said to be non-interactive. A local user may login to additional windows such that the processes executed in the service window are not run in the same window as the user window. As such, the processes that run in the service window, such as hardware driver processes, install processes, etc. are prevented from attach through a user window.

However, if a background application generates a UI element requesting a user to click an “OK” button, the user may never see this as it is part of the non-interactive service window. As such, the associated process may be indefinitely hanging as this user input may never be received. Accordingly, the agent (214) may monitor for these hung, idle, stalled user-interactive processes, or other inactive processes and take a remedial action as described above.

As described above, the process characteristics (104) that are monitored and the threshold criteria (108) by which a process is deemed inactive, may be user-defined. Accordingly, an administrator may access a server (212) to setup the agent monitoring. Specifically, the administrator may determine which processes are to be monitored, criteria by which it is determined which processes are monitored, process characteristics (104) that are to be tracked, threshold criteria (108) against which the process characteristics (104) are measured, and remedial actions that are taken responsive to identification of an inactive process. As such, the present system (100) may be executed on a thin client (210) that relies on a server (212) to provide physical and processing resources.

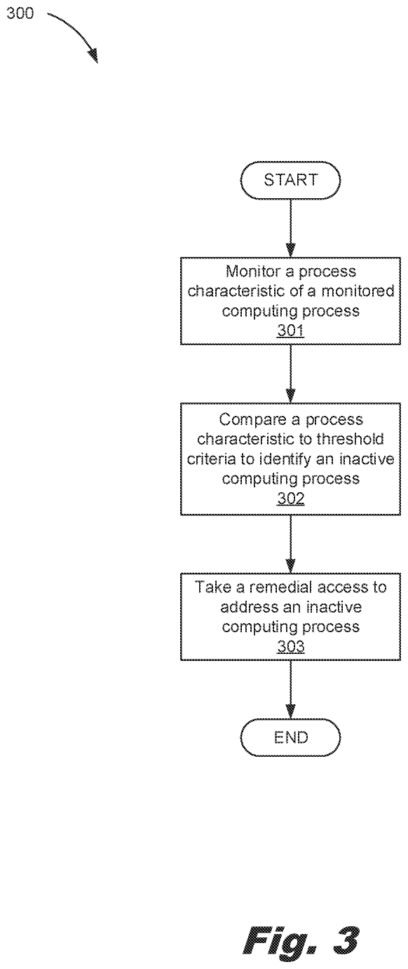

FIG. 3 is a flowchart of a method (300) for identifying inactive computing processes, according to an example of the principles described herein. As described above, processes executed by a computing device such as a thin client (210) may be organized as a hierarchy with some processes calling other processes and with some processes being triggered by the successful execution of another process. Accordingly, for the processing hierarchy, a process monitor (102) may monitor (block 301) a process characteristic (104) of a monitored computing process. Such monitoring may have a number of parameters including the monitored processes and the process characteristics (104) that are to be monitored. The monitoring may include other parameters. For example, there may be a checking interval which may indicate how often the process monitor (102) is to check the monitored process for the process characteristic (104).

The monitoring parameters may also include a time interval after which an assessment is made regarding process activity/inactivity. That is, the time interval may indicate how many checking intervals occur before an assessment is made. For example, the checking interval may be one second and the time interval may be 60 seconds, or 60 checking instances. At the expiration of the time interval, (e.g., 60 seconds), the controller (106) may compare (block 302) a process characteristic (104) to threshold criteria (108) to identify an inactive computing process. In a particular example, the time interval may be thirty seconds, one minute, or two minutes. Thus, the present method (300) identifies an inactive process on the time order of magnitude of 1-2 minutes rather than on a much larger and longer time scale.

In an example, the comparison includes determining how many measured process characteristics (104) meet the threshold criteria for inactivity. For example, as described above, one process characteristic (104) exceeding or falling under a particular threshold may be indicative, but not dispositive of process activity. Accordingly, by evaluating the process characteristic (104) multiple times over a given time interval, a clear and accurate determination of process activity or inactivity may be made.

To provide an even more clear and accurate determination, a similar process may be performed for additional process characteristics (104). For example, multiple process characteristics (104) may be tracked over the time interval, each instance compared against the threshold criteria (108). The corpus of these measurements may be evaluated to determine if a process is inactive.

As such, at the end of the time interval, the controller (106) has various pieces of information to determine inactivity. If a threshold number of measured process characteristics (108) meet the threshold criteria (108), then the controller (106) may designate the process as inactive.

Responsive to an identification of an inactive process, the controller (106) may take a variety of remedial actions such as providing a notification to an administrator of the inactive computing process or re-executing the computing process as described above.

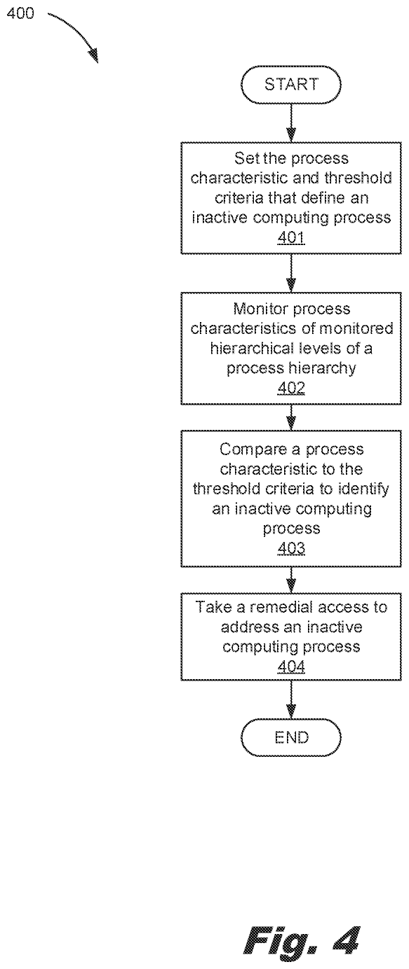

FIG. 4 is a flowchart of a method (400) for identifying inactive computing processes, according to an example of the principles described herein. As described above, a process may be identified as active or inactive based on 1) the process characteristics (104) that are monitored and 2) the threshold criteria (108) against which the process characteristics (104) are compared. In this example, the method (400) includes setting (block 401) the process characteristics (104) and the threshold criteria (108) that are used to identify the inactive computing process. For example, based on the computing devices, processes, and computing environment, certain processes may be more prone to become stalled and impact the operation of the computing device while others may not be as relevant or prone to stalling. Accordingly, an administrator, or the system (100) itself may determine which processes are to be monitored and which process characteristics are to be monitored and tracked to identify stalled processes.

Similarly, the controller (106) may set, either automatically or based on user input, the threshold criteria (108) against which the process characteristics are compared. Again, certain applications, processes, and hardware resources may dictate different criteria against which the process characteristics (104) are measured to identify inactive processes. As such, the threshold criteria (108) may be set by an administrator or the controller (106) automatically.

The process characteristics (104) are then monitored (block 402) as described above in connection with FIG. 3. Specifically, the process monitor (102) may monitor different hierarchical levels of the process hierarchy by traversing the process hierarchy. Specifically, the process monitor (102) monitors the process characteristics (104) of the hierarchy to ultimately identify the inactive computing process.

With the process characteristic (104) data collected for the process hierarchy, the controller (106) may compare (block 403) a process characteristic to threshold criteria (108) to identify an inactive computing process and take (block 404) a remedial action to address the inactive computing process. These operations may be performed as described above in connection with FIG. 3.

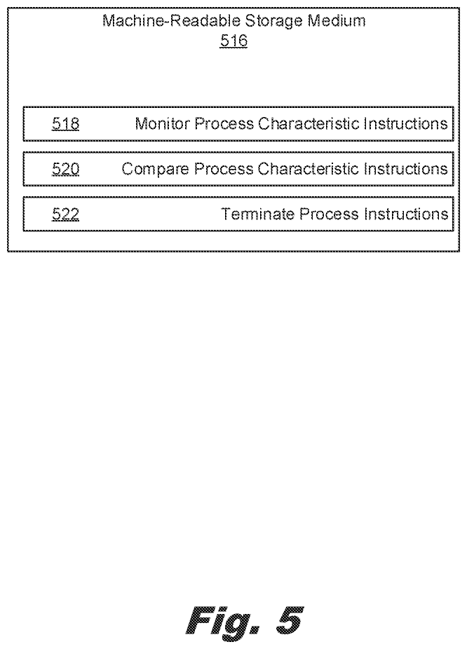

FIG. 5 depicts a non-transitory machine-readable storage medium (516) for identifying inactive computing processes, according to an example of the principles described herein. To achieve its desired functionality, the system (100) includes various hardware components. Specifically, the system (100) includes a processor and a machine-readable storage medium (516). The machine-readable storage medium (516) is communicatively coupled to the processor. The machine-readable storage medium (516) includes several instructions (518, 520, 522) for performing a designated function. In some examples, the instructions may be machine code and/or script code.

The machine-readable storage medium (516) causes the processor to execute the designated function of the instructions (518, 520, 522). The machine-readable storage medium (516) can store data, programs, instructions, or any other machine-readable data that can be utilized to operate the system (100). Machine-readable storage medium (516) can store machine-readable instructions that the processor of the system (100) can process, or execute. The machine-readable storage medium (516) can be an electronic, magnetic, optical, or other physical storage device that contains or stores executable instructions. Machine-readable storage medium (516) may be, for example, Random-Access Memory (RAM), an Electrically Erasable Programmable Read-Only Memory (EEPROM), a storage device, an optical disc, etc. The machine-readable storage medium (516) may be a non-transitory machine-readable storage medium (516).

Monitor process characteristic instructions (518), when executed by the processor, cause the processor to, for each process, monitor a process characteristic (104) of a monitored computing process. Compare process characteristic instructions (520), when executed by the processor, cause the processor to, for each parent and child process, compare a process characteristic (104) to threshold criteria (108) for the process characteristic (104) at the expiration of a time interval to identify an inactive computing process. Terminate process instructions (522), when executed by the processor, cause the processor to, for each parent and child process, terminate an inactive computing process.

As described above, such a system, method, and machine-readable storage medium may, for example, 1) provide enhanced monitoring of parent and child processes in a process hierarchy; 2) provide quicker resolution of inactive processes; 3) reduce strain and free processing resources from queued up and stalled processes; and 4) allow execution of downstream processes of a stalled process. However, it is contemplated that the device, method, and machine-readable storage medium disclosed herein may address other matters and deficiencies in a number of technical areas, for example.

What is claimed is:

1. A system, comprising:
a process monitor to:
identify a computing process to monitor; and
monitor a process characteristic of a monitored computing process; and
a controller to:
compare process characteristic to threshold criteria for the process characteristic to identify an inactive computing process; and
responsive to identification of an inactive computing process, take a remedial action to address the inactivity.

2. The system of claim 1, wherein the system is an agent installed on a client computing device, wherein a server computing device provides an operating system to the client computing device.

3. The system of claim 1, wherein the process characteristic comprises:
central processing unit (CPU) usage;
process thread number;
process memory usage;
process handle number;
disk activity associated with the process characteristic;
network input/output;
user interface status;
user prompt status;
computing device sleep state;
responsive state of an application associated with the process; or
a combination thereof.

4. The system of claim 1, wherein the computing process is a child process reliant on a parent process.

5. The system of claim 1, wherein the threshold criteria indicates a process characteristic maintains a constant value over a predetermined period of time.

6. A method, comprising:
for a process hierarchy executing on a computing device:
monitoring a process characteristic of a monitored computing process;
at an expiration of a time interval, comparing a process characteristic to threshold criteria for the process characteristic to identify an inactive computing process; and
responsive to identification of an inactive computing process, taking a remedial action to address the inactivity.

7. The method of claim 6, further comprising monitoring different hierarchical levels of the process hierarchy.

8. The method of claim 6, wherein taking the remedial action comprises providing a notification to an administrator of the inactive computing process.

9. The method of claim 6, wherein taking the remedial action comprises re-executing the computing process.

10. The method of claim 6, further comprising setting the process characteristic and threshold criteria that identify the inactive computing process.

11. A non-transitory machine-readable storage medium encoded with instructions executable by a processor, the machine-readable storage medium comprising instructions to:
for each process executing on a computing device:
monitor a process characteristic of a monitored computing process;
at an expiration of a time interval, compare a process characteristic to threshold criteria for the process characteristic to identify an inactive computing process; and
responsive to identification of an inactive computing process, terminate the inactive computing process.

12. The non-transitory machine-readable storage medium of claim 11, wherein an inactive computing process comprises:
a stalled computing process;
an idle computing process; a
a computing process awaiting user input; or
a combination thereof.

13. The non-transitory machine-readable storage medium of claim 11, wherein the instructions are executable by the processor to compare multiple process characteristics to respective threshold criteria to identify the inactive computing process.

14. The non-transitory machine-readable storage medium of claim 11, wherein the instructions are executable to traverse a process hierarchy to identify the inactive computing process.

15. The non-transitory machine-readable storage medium of claim 11, wherein the monitored computing process is a child process of an exited parent process.
